(19) United States
(12) Patent Application Publication
(10) Pub. No.: US 2026/0268903 A1
(43) Pub. Date: Sep. 10, 2026

(54) WAKE-UP METHOD AND APPARATUS FOR ARTIFICIAL INTELLIGENCE ASSISTANT, DEVICE, AND STORAGE MEDIUM

(71) Applicant: Beijing Zitiao Network Technology Co., Ltd., Beijing (CN)

(72) Inventor: Jiajie Zhang, Beijing (CN)

(21) Appl. No.: 19/364,829

(22) Filed: Oct. 21, 2025

(30) Foreign Application Priority Data
Mar. 10, 2025 (CN) 202510280441.X

(51) Int. Cl. G10L 15/22; G06F 9/4401; H04R 1/10

(52) U.S. Cl. CPC G10L 15/22; G06F 9/4418; H04R 1/1041; H04R 2420/07

(57) ABSTRACT

A wake-up method and apparatus for artificial intelligence assistant, a device, and a storage medium. The method includes: when a voice wake-up module of the voice input device is in an on state, if voice information input by a user is detected, recognizing whether the voice information satisfies a voice wake-up condition, and waking up the artificial intelligence assistant of the target application when the voice information satisfies the voice wake-up condition; when a button wake-up module of the voice input device is in an on state, if a button operation of the user is detected, recognizing whether the button operation satisfies a button wake-up condition, and waking up the artificial intelligence assistant of the target application when the button operation satisfies the button wake-up condition.

### CROSS-REFERENCE TO RELATED APPLICATION

The present application claims priority to Chinese Patent Application No. 202510280441.X, filed on Mar. 10, 2025, which is incorporated herein by reference in its entirety as a part of the present application.

### TECHNICAL FIELD

Embodiments of the present disclosure relate to the field of artificial intelligence technologies, and in particular, to a wake-up method and apparatus for artificial intelligence assistant, a device, and a storage medium.

### BACKGROUND

With the development of artificial intelligence technologies, more and more users install applications with an artificial intelligence assistant, and get questions answered by the artificial intelligence assistant of the applications. For example, the users may ask the artificial intelligence assistant questions such as "What's the weather today" and "What's the definition of photosynthesis".

In the prior art, the artificial intelligence assistant needs to be woken up before it is used. For example, the artificial intelligence assistant is woken up through a preset wake-up word "XX". Moreover, in order to improve user experience, many applications also support waking up the artificial intelligence assistant through a wearable device such as a Bluetooth headset or smart audio glasses.

The inventor(s) found that the prior art at least involves the following technical problem: some Bluetooth headsets have overlapping operational logics, which easily leads to mis-triggering of the wake-up of the artificial intelligence assistant, thus reducing the user experience.

### SUMMARY

Embodiments of the present disclosure provide a wake-up method and apparatus for artificial intelligence assistant, a device, and a storage medium, which may improve the flexibility of the wake-up method, thus improving the user experience.

In a first aspect, an embodiment of the present disclosure provides a wake-up method for artificial intelligence assistant, which is applied to a voice input device of a target application, where the target application is an application with an artificial intelligence assistant, and the method includes:

in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition;

in response to a button wake-up module of the voice input device being in an on state, and a button operation of the user being detected, recognizing whether the button operation satisfies a button wake-up condition, and waking up the artificial intelligence assistant of the target application in response to the button operation satisfying the button wake-up condition;

where the voice wake-up module and the button wake-up module of the voice input device are controlled based on a voice wake-up switch and a button wake-up switch of the target application, respectively.

In a second aspect, an embodiment of the present disclosure provides a wake-up apparatus for artificial intelligence assistant, which is applied to a voice input device of a target application, where the target application is an application with an artificial intelligence assistant, and the apparatus includes:

a first wake-up module, configured to: in response to a voice wake-up module of the voice input device being in an on state, and voice information that is input by a user being detected, recognize whether the voice information satisfies a voice wake-up condition, and wake up the artificial intelligence assistant of the target application in response to the voice information satisfying the voice wake-up condition;

a second wake-up module, configured to: in response to a button wake-up module of the voice input device being in an on state, and a button operation of the user being detected, recognize whether the button operation satisfies a button wake-up condition, and wake up the artificial intelligence assistant of the target application in response to the button operation satisfying the button wake-up condition;

where the voice wake-up module and the button wake-up module of the voice input device are controlled based on a voice wake-up switch and a button wake-up switch of the target application, respectively.

In a third aspect, an embodiment of the present disclosure provides an electronic device, including: at least one processor and a memory;

the memory stores computer-executable instructions; and

the computer-executable instructions stored in the memory, when executed by the at least one processor, cause the at least one processor to perform the wake-up method for artificial intelligence assistant according to the above first aspect and various possible designs of the first aspect.

In a fourth aspect, an embodiment of the present disclosure provides a non-transient computer-readable storage medium, where computer-executable instructions are stored in the computer-readable storage medium, and the computer-executable instructions, when executed by at least one processor, cause the at least one processor to perform the wake-up method for artificial intelligence assistant according to the above first aspect and various possible designs of the first aspect.

In a fifth aspect, an embodiment of the present disclosure provides a computer program product, including a computer program, and the computer program, when executed by at least one processor, cause the at least one processor to perform the wake-up method for artificial intelligence assistant according to the above first aspect and various possible designs of the first aspect.

### BRIEF DESCRIPTION OF DRAWINGS

In order to more clearly explain the technical solutions in the embodiments of the present disclosure or in the prior art, the drawings necessary for the description of the embodiments or the prior art will be briefly introduced in the following. Obviously, the drawings in the following description are some embodiments of the present disclosure. For those of ordinary skill in the art, other drawings may be obtained based on these drawings without paying creative efforts.

FIG. 1 is a first flowchart of a wake-up method for artificial intelligence assistant provided by an embodiment of the present disclosure;

FIG. 2 is a first schematic diagram of a setting interface of a target application provided by an embodiment of the present disclosure;

FIG. 3 is a first schematic diagram of a wake-up method for artificial intelligence assistant provided by an embodiment of the present disclosure;

FIG. 4 is a second schematic diagram of a wake-up method for artificial intelligence assistant provided by an embodiment of the present disclosure;

FIG. 5 is a schematic structural diagram of a wake-up apparatus for artificial intelligence assistant provided by an embodiment of the present disclosure; and

FIG. 6 is a schematic structural diagram of an electronic device provided by an embodiment of the present disclosure.

### DETAILED DESCRIPTION

In order to make the objectives, technical solutions and advantages of the embodiments of the present disclosure clearer, the technical solutions in the embodiments of the present disclosure will be described clearly and comprehensively below in combination with the drawings in the embodiments of the present disclosure. Obviously, the described embodiments are part of the embodiments of the present disclosure, not all of them. Based on the embodiments in the present disclosure, all other embodiments obtained by persons of ordinary skill in the art without creative efforts fall within the protection scope of the present disclosure.

It should be noted that the user information (including but not limited to user device information, user personal information, etc.) and data (including but not limited to data for analysis, stored data, displayed data, etc.) involved in one or more embodiments of this specification are information and data authorized by the user or fully authorized by all parties, and the collection, use and processing of relevant data need to comply with relevant laws, regulations and standards, and provide corresponding operation entrance for the user to choose authorization or rejection.

With the development of artificial intelligence technologies, more and more users install applications with an artificial intelligence assistant, and get answers to their questions by using the artificial intelligence assistant of the applications. For example, the users may ask the artificial intelligence assistant questions such as "What's the weather today" and "What's the definition of photosynthesis".

In the related art, the artificial intelligence assistant needs to be woken up before it is used. For example, the artificial intelligence assistant is woken up through a preset wake-up word "XX". Moreover, in order to improve user experience, many applications also support waking up the artificial intelligence assistant through a Bluetooth headset. For example, the user's voice is collected through the headset to wake up the artificial intelligence assistant, or the artificial intelligence assistant is woken up through a touch button on the headset.

However, since the gesture operations of the headset itself are also implemented through the button, enabling the functions such as skipping to the previous track, skipping to the next track, and pausing, etc., during the implementation of the function of waking up the artificial intelligence assistant through the Bluetooth headset, there may be a situation that the gesture operation and the button wake-up are coupled; in addition, there may also be a situation that the voice wake-up and the button wake-up are coupled. This leads to problems in the system in terms of function control, power consumption management, compatibility, etc., which affects the performance of the Bluetooth headset and the user experience. For example, some Bluetooth headsets have overlapping operational logics, which easily leads to mis-triggering of the wake-up of the artificial intelligence assistant, thus reducing the user experience.

In view of the technical problems in the prior art, the technical conception of the inventor(s) is as follows: by setting multiple wake-up switches and configuring the control logic of each wake-up switch, the decoupling of multiple wake-up modes is realized. The user may freely choose to enable one or more wake-up modes, which may improve the flexibility of the wake-up modes.

Correspondingly, the specific steps may include: when a voice wake-up module of the voice input device is in an on state, if voice information input by a user is detected, recognizing whether the voice information satisfies a voice wake-up condition, and waking up an artificial intelligence assistant of a target application when the voice information satisfies the voice wake-up condition; and when a button wake-up module of the voice input device is in an on state, if a button operation of the user is detected, recognizing whether the button operation satisfies a button wake-up condition, and waking up the artificial intelligence assistant of the target application when the button operation satisfies the button wake-up condition. The voice wake-up module and the button wake-up module of the voice input device are controlled based on a voice wake-up switch and a button wake-up switch of the target application, respectively.

In this technical solution, since the on/off states of the voice wake-up module and the button wake-up module may be separately controlled through the voice wake-up switch and the button wake-up switch of the target application, decoupling of voice wake-up and button wake-up is realized. As such, the user may freely choose to enable one or more wake-up modes, thereby improving the flexibility of the wake-up method and the user experience.

The following is a specific implementation process of a wake-up method and apparatus for artificial intelligence assistant according to embodiments of the present disclosure, and some examples are only illustrative and not limitative. An execution body of the wake-up method for artificial intelligence assistant involved in the embodiments of the present disclosure is an electronic device, and the electronic device may be a voice input device or the like.

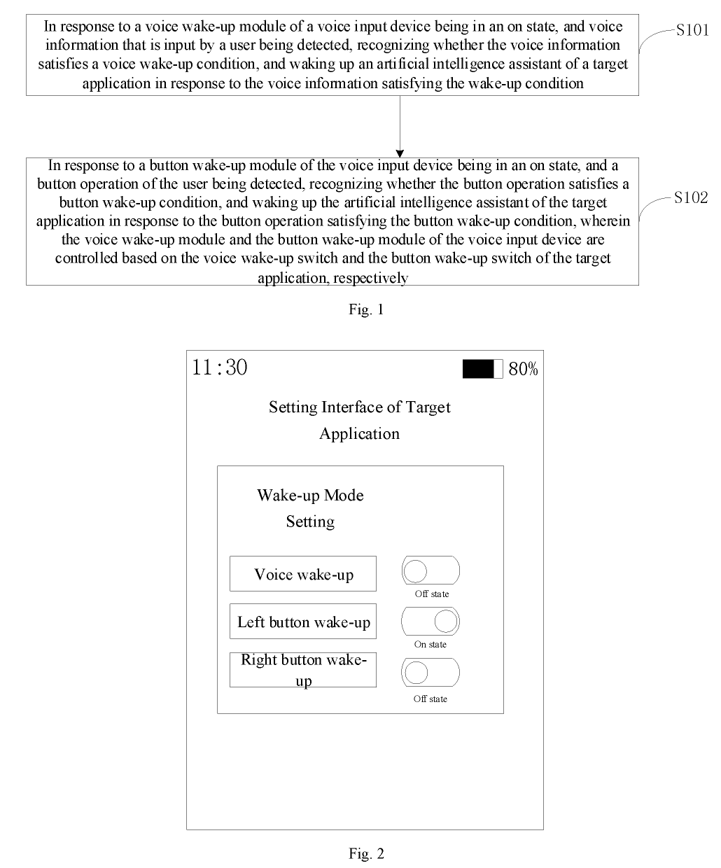

FIG. 1 is a first flowchart of a wake-up method for artificial intelligence assistant provided by an embodiment of the present disclosure, which is applied to a voice input device of a target application, where the target application is an application with an artificial intelligence assistant. As shown in FIG. 1, the method includes:

S101: in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition.

In the embodiment of the present disclosure, the voice input device is a device that may receive voice information. Optionally, the voice input device is a Bluetooth headset, a pair of Bluetooth audio glasses, a Bluetooth speaker, or the like.

Optionally, the voice wake-up condition is that the voice information includes a wake-up word. The wake-up word may be set in a configuration option of the voice wake-up condition.

Exemplarily, the wake-up word is "XX, XX". If the voice information input by the user is detected, it may be recognized by the voice wake-up module whether the voice information includes the wake-up word "XX, XX". When the voice information includes the wake-up word "XX, XX", a wake-up instruction is sent to the target application to wake up the artificial intelligence assistant of the target application.

S102: in response to the button wake-up module of the voice input device being in the on state, and the button operation of the user being detected, recognizing whether the button operation satisfies a button wake-up condition, and waking up the artificial intelligence assistant of the target application in response to the button operation satisfying the button wake-up condition, where the voice wake-up module and the button wake-up module of the voice input device are controlled based on a voice wake-up switch and a button wake-up switch of the target application, respectively.

In the embodiment of the present disclosure, the button operation may be a pressing operation on a physical button or a pressing operation on a touch button.

Optionally, the button wake-up condition is that the pressing duration of the pressing operation reaches a preset duration. The value of the preset duration is not specifically limited. For example, the preset duration may be 1 second, 2 seconds, 3 seconds, etc.

Exemplarily, the button wake-up condition is that the trigger duration of the button operation reaches 1 second. In this case, if the button operation of the user is detected, it is recognized whether the trigger duration of the button operation reaches 1 second. When the trigger duration reaches 1 second, a wake-up instruction is sent to the target application to wake up the artificial intelligence assistant of the target application.

Optionally, the button wake-up condition is the number of pressing operations, such as single-click, double-click, triple-click, etc.

Exemplarily, the button wake-up condition is double-clicking the button. In this case, if the button operation of the user is detected, the number of pressing operations is recognized. If the number of pressing operations is 2 (that is, double-clicking the button), a wake-up instruction is sent to the target application to wake up the artificial intelligence assistant of the target application.

In some embodiments, the setting interface of the target application includes the voice wake-up switch and the button wake-up switch, the voice wake-up module may be controlled through the voice wake-up switch, and the button wake-up module may be controlled through the button wake-up switch.

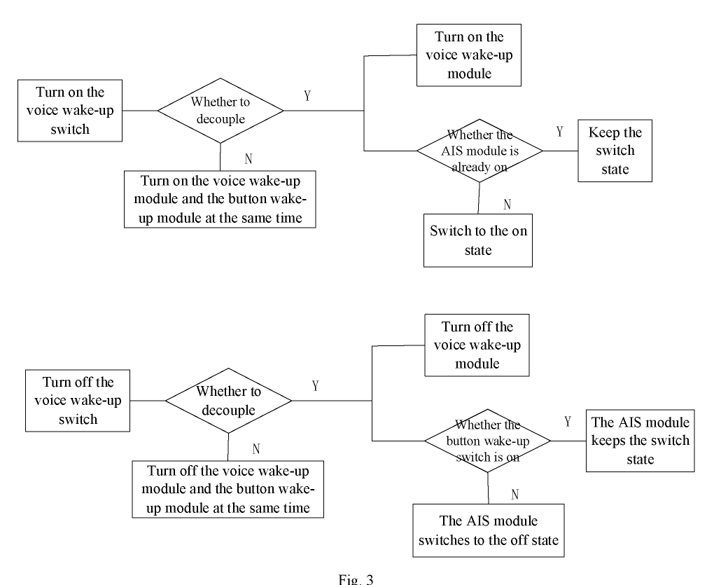

In some other embodiments, the voice input device includes a Bluetooth headset, and the Bluetooth headset includes a left headset and a right headset; accordingly, as shown in FIG. 2, the button wake-up switch in the setting interface of the target application includes a left button wake-up switch and a right button wake-up switch, where the left button wake-up switch is configured to control a button wake-up module of the left headset, and the right button wake-up switch is configured to control a button wake-up module of the right headset.

The embodiment of the present disclosure provides a wake-up method for artificial intelligence assistant. The method includes: when a voice wake-up module of a voice input device is in an on state, if voice information input by a user is detected, recognizing whether the voice information satisfies a voice wake-up condition, and waking up an artificial intelligence assistant of a target application when the voice information satisfies the voice wake-up condition; and when a button wake-up module of the voice input device is in an on state, if a button operation of the user is detected, recognizing whether the button operation satisfies a button wake-up condition, and waking up the artificial intelligence assistant of the target application when the button operation satisfies the button wake-up condition. The voice wake-up module and the button wake-up module of the voice input device are controlled based on a voice wake-up switch and a button wake-up switch of the target application, respectively. In the embodiment of the present disclosure, since the on/off states of the voice wake-up module and the button wake-up module may be separately controlled through the voice wake-up switch and the button wake-up switch of the target application, decoupling of voice wake-up and button wake-up is realized. As such, the user may freely choose to enable one or more wake-up modes, thereby improving the flexibility of the wake-up method and the user experience.

In the embodiment of the present disclosure, the artificial intelligence assistant module on the voice input device may be an AIS (Artificial Intelligence Subsystem).

Optionally, the voice input device is a Bluetooth headset, and the Bluetooth headset includes a left headset and a right headset. The artificial intelligence assistant module may be deployed on the left headset and/or the right headset. The main functions of the artificial intelligence assistant module include voice wake-up and recording, and cooperation with the AI (Artificial Intelligence) module on the target application side to provide intelligent voice functions.

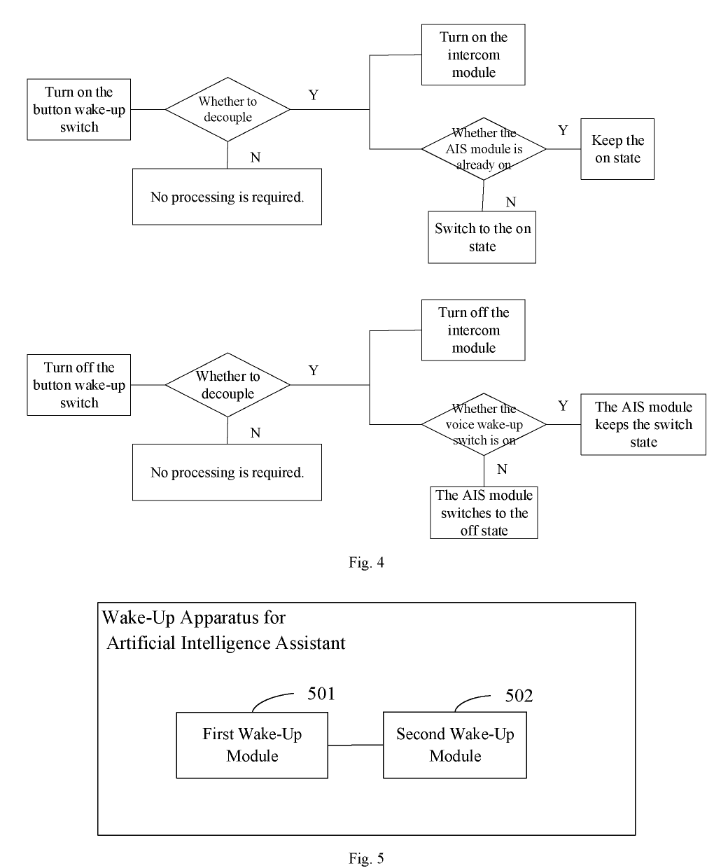

In some embodiments, as shown in FIG. 3 and FIG. 4, the working state of the artificial intelligence assistant module is adjusted according to the voice wake-up switch and the button wake-up switch. When the voice wake-up switch and the button wake-up switch are both in the off state, the artificial intelligence assistant module is turned off. When one or more of the voice wake-up switch and the button wake-up switch are in the on state, the artificial intelligence assistant module is turned on.

In some other embodiments, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset.

In this case, the working state of the artificial intelligence assistant module is adjusted according to the voice wake-up switch, the left button wake-up switch and the right button wake-up switch. When the voice wake-up switch, the left button wake-up switch and the right button wake-up switch are all in the off state, the artificial intelligence assistant module is turned off. When one or more of the voice wake-up switch, the left button wake-up switch and the right button wake-up switch are in the on state, the artificial intelligence assistant module is turned on.

A control method of the voice wake-up module and the button wake-up module of the voice input device is described in detail below through four scenarios of turning on the voice wake-up switch, turning off the voice wake-up switch, turning on the button wake-up switch and turning off the button wake-up switch.

The first case is for the scenario of turning on the voice wake-up switch.

Controlling the voice wake-up module of the voice input device based on the voice wake-up switch of the target application includes the following steps 11 to 12:

Step 11, in response to receiving first control information sent by the target application based on a target device, where the first control information is triggered by the target application when the voice wake-up switch is turned on, and the target device is a terminal device that is connected to the voice input device through Bluetooth;

Step 12, turning on the voice wake-up module of the voice input device, and acquiring a working state of the artificial intelligence assistant module of the voice input device, and if the working state of the artificial intelligence assistant module is an off state, switching the working state of the artificial intelligence assistant module to an on state, where the artificial intelligence assistant module is configured to detect voice information input by the user, and the voice wake-up module is configured to recognize whether the voice information satisfies the voice wake-up condition.

It should be noted that in some embodiments, the voice input device may be a device installed with new version software or a device installed with old version software. The device with the new version software supports decoupling of the voice wake-up module and the button wake-up module, while the device with the old version software does not support the decoupling of the voice wake-up module and the button wake-up module.

In this case, as shown in FIG. 3, when the first control information is received, it may be determined whether the voice input device supports decoupling according to a software version of the voice input device. If the voice input device supports decoupling, the above step 12 is continued to be executed. If the voice input device does not support decoupling, the voice wake-up module and the button wake-up module of the voice input device are turned on at the same time.

In some other embodiments, the target application may be an old version application before a decoupling function upgrade or a new version application after the decoupling function upgrade. At this time, when the first control information is received, it may be determined whether the voice input device supports decoupling according to the software version of the voice input device and a software version of the target application. If the software version of the voice input device and the software version of the target application are both new versions, it is determined that the voice input device supports decoupling. If the software version of the voice input device or the software version of the target application is an old version, it is determined that the voice input device does not support decoupling.

The second case is for the scenario of turning off the voice wake-up switch.

Controlling the voice wake-up module of the voice input device based on the voice wake-up switch of the target application includes the following steps 21 to 22:

Step 21, in response to receiving second control information sent by the target application based on a terminal device, where the second control information is triggered by the target application when the voice wake-up switch is turned off.

Step 22, turning off the voice wake-up module of the voice input device, detecting a switch state of the button wake-up switch, and if the button wake-up switch is in an off state, switching the working state of the artificial intelligence assistant module to an off state, and if the button wake-up switch is in an on state, keeping the working state of the artificial intelligence assistant module in an on state.

Continuing to refer to FIG. 3, when the second control information is received, it may be determined whether the voice input device supports decoupling according to the software version of the voice input device. If the voice input device supports decoupling, the above step 22 is continued to be executed. If the voice input device does not support decoupling, the voice wake-up module and the button wake-up module of the voice input device are turned off at the same time.

The third case is for the scenario of turning on the button wake-up switch.

Controlling the button wake-up module of the voice input device based on the button wake-up switch of the target application includes the following steps 31 to 32:

Step 31, in response to receiving third control information sent by the target application based on a target device, turning on the button wake-up module of the voice input device, where the third control information is triggered by the target application when the button wake-up switch is turned on, and the target device is a terminal device that is connected to the voice input device through Bluetooth;

Step 32, turning on the intercom module of the voice input device, and acquiring the working state of the artificial intelligence assistant module of the voice input device, and if the working state of the artificial intelligence assistant module is an off state, switching the working state of the artificial intelligence assistant module to an on state, where the intercom module is configured to receive, through the artificial intelligence assistant module after the artificial intelligence assistant of the target application is woken up, voice information input by the user.

Optionally, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset.

In some embodiments, in order to save power consumption of the Bluetooth headset, it only needs to turn on the artificial intelligence assistant module of the main headset when necessary, and the voice information input by the user is received through the artificial intelligence assistant module of the main headset. Optionally, the left headset is the main headset, and the right headset is the slave headset. Accordingly, the step 32 may include:

if the third control information is triggered by the target application when the left button wake-up switch is turned on, turning on the button wake-up module of the left headset, turning on the intercom module of the left headset, and acquiring the working state of the artificial intelligence assistant module of the left headset, and if the working state of the artificial intelligence assistant module is an off state, switching the working state of the artificial intelligence assistant module to an on state; and

if the third control information is triggered by the target application when the right button wake-up switch is turned on, turning on the button wake-up module of the right headset, turning on the intercom module of the right headset, and acquiring the working state of the artificial intelligence assistant module of the left headset, and if the working state of the artificial intelligence assistant module is an off state, switching the working state of the artificial intelligence assistant module to an on state.

It should be noted that, as shown in FIG. 4, when the third control information is received, it may be determined whether the voice input device supports decoupling according to the software version of the voice input device. If the voice input device supports decoupling, the above step 32 is continued to be executed. If the voice input device does not support decoupling, no processing is performed.

The fourth case is for the scenario of turning off the button wake-up switch.

Controlling the button wake-up module of the voice input device based on the button wake-up switch of the target application includes the following steps 41 to 42:

Step 41, in response to receiving fourth control information sent by the target application based on a terminal device, turning off the button wake-up module of the voice input device, where the fourth control information is triggered by the target application when the button wake-up switch is turned off; and

Step 42, turning off the intercom module of the voice input device, and detecting a switch state of the voice wake-up switch, and if the voice wake-up switch is in an off state, switching the working state of the artificial intelligence assistant module to an off state, and if the voice wake-up switch is in an on state, keeping the working state of the artificial intelligence assistant module in an on state.

Optionally, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset.

In some embodiments, in order to save power consumption of the Bluetooth headset, it only needs to turn on the artificial intelligence assistant module of the main headset when necessary. Optionally, the left headset is the main headset, and the right headset is the slave headset. Accordingly, the step 42 may include:

if the fourth control information is triggered by the target application when the left button wake-up switch is turned on, turning off the intercom module of the left headset, and detecting the switch state of the voice wake-up switch and a switch state of the right button wake-up switch, and if the voice wake-up switch and the right button wake-up switch are both in the off state, switching the working state of the artificial intelligence assistant module of the left headset to an off state, and if the voice wake-up switch is in the on state and/or the right button wake-up switch is in the on state, keeping the working state of the artificial intelligence assistant module of the left headset in an on state; and

if the fourth control information is triggered by the target application when the right button wake-up switch is turned on, turning off the intercom module of the right headset, and detecting the switch state of the voice wake-up switch and a switch state of the left button wake-up switch, and if the voice wake-up switch and the left button wake-up switch are both in the off state, switching the working state of the artificial intelligence assistant module of the left headset to an off state, and if the voice wake-up switch is in the on state and/or the left button wake-up switch is in the on state, keeping the working state of the artificial intelligence assistant module of the left headset in an on state.

Optionally, as shown in FIG. 4, when the fourth control information is received, it may be determined whether the voice input device supports decoupling according to the software version of the voice input device. If the voice input device supports decoupling, the above step 42 is continued to be executed. If the voice input device does not support decoupling, no processing is performed.

It should be noted that if the device state of the voice input device does not satisfy the wake-up condition, the voice wake-up module, the button wake-up module, the artificial intelligence assistant module and the intercom module may be turned off.

In some embodiments, when the device state does not satisfy the wake-up condition, the state control method of each module may include: in response to the device state of the voice input device being in a first device state, turning off the voice wake-up module, the button wake-up module, the artificial intelligence assistant module and the intercom module of the voice input device, where the first device state includes a call state, a charging state or a power-off state.

In some other embodiments, the voice input device includes a Bluetooth headset; the Bluetooth headset includes a left headset and a right headset, the left headset is a main headset, and the right headset is a slave headset.

Correspondingly, when the device state does not satisfy the wake-up condition, the state control method of each module of the left headset and the right headset may include: in response to a device state of the left headset being in a first device state, turning off a voice wake-up module, a button wake-up module, an artificial intelligence assistant module and an intercom module of the left headset; and in response to a device state of the right headset being in the first device state, turning off a button wake-up module and an intercom module of the right headset, where the first device state includes a call state, a charging state or a power-off state.

In the embodiment of the present disclosure, since modules such as the voice wake-up module, the button wake-up module, the artificial intelligence assistant module and the intercom module of the left headset may be turned off in time when the voice input device enters the call state, the charging state or the power-off state, the power consumption of the voice input device is reduced, and the user experience of the voice input device is improved.

In some embodiments, the voice input device includes a Bluetooth headset; the Bluetooth headset includes a left headset and a right headset, the left headset is a main headset, and the right headset is a slave headset. Optionally, when the main headset is switched to the slave headset, the state control method of each module of the main headset includes:

in response to the left headset being switched from the main headset to the slave headset, turning off the voice wake-up module and the artificial intelligence assistant module of the left headset, and detecting a switch state of a button wake-up switch of the left headset, and if the button wake-up switch of the left headset is in an on state, keeping a button wake-up module and the intercom module of the left headset in an on state, and if the button wake-up switch of the left headset is in an off state, turning off the button wake-up module and the intercom module of the left headset.

In the embodiment of the present disclosure, when the Bluetooth headset includes the left headset and the right headset, it only needs to turn on the voice wake-up module and the artificial intelligence assistant module of one headset. In this case, when the main headset is switched to the slave headset, the voice wake-up module and the artificial intelligence assistant module of this headset may be turned off to reduce power consumption, thereby improving the flexibility of controlling the Bluetooth headset and further improving the user experience.

Further, in order to improve the control efficiency of the voice wake-up module and the button wake-up module, when the target application is bound to the voice input device, the voice wake-up switch and the button wake-up switch may be set to be both in the on state. When the binding between the target application and the voice input device is released, the voice wake-up switch and the button wake-up switch may be set to be both in the off state.

Correspondingly, the method may further include:

in response to a binding operation between the target application and the voice input device, turning on the voice wake-up module, the button wake-up module, the artificial intelligence assistant module and the intercom module of the voice input device; and

in response to an unbinding operation between the target application and the voice input device, turning off the voice wake-up module, the button wake-up module, the artificial intelligence assistant module and the intercom module of the voice input device.

FIG. 5 is a schematic structural diagram of a wake-up apparatus for artificial intelligence assistant provided by an embodiment of the present disclosure. As shown in FIG. 5, the wake-up apparatus for artificial intelligence assistant includes:

a first wake-up module 501, configured to: in response to a voice wake-up module of the voice input device being in an on state, and voice information that is input by a user being detected, recognize whether the voice information satisfies a voice wake-up condition, and wake up the artificial intelligence assistant of the target application in response to the voice information satisfying the voice wake-up condition;

a second wake-up module 502, configured to: in response to a button wake-up module of the voice input device being in an on state, and a button operation of the user being detected, recognize whether the button operation satisfies a button wake-up condition, and wake up the artificial intelligence assistant of the target application in response to the button operation satisfying the button wake-up condition;

where the voice wake-up module and the button wake-up module of the voice input device are controlled based on a voice wake-up switch and a button wake-up switch of the target application, respectively.

According to one or more embodiments of the present disclosure, the voice input device includes a Bluetooth headset, and the Bluetooth headset includes a left headset and a right headset; the button wake-up switch of the target application includes a left button wake-up switch and a right button wake-up switch, where the left button wake-up switch is configured to control a button wake-up module of the left headset, and the right button wake-up switch is configured to control a button wake-up module of the right headset.

According to one or more embodiments of the present disclosure, controlling the voice wake-up module of the voice input device based on the voice wake-up switch of the target application includes: in response to receiving first control information sent by the target application based on a target device, turning on the voice wake-up module of the voice input device, where the first control information is triggered by the target application when the voice wake-up switch is turned on, and the target device is a terminal device that is connected to the voice input device through Bluetooth; and acquiring a working state of the artificial intelligence assistant module of the voice input device, and if the working state of the artificial intelligence assistant module is an off state, switching the working state of the artificial intelligence assistant module to an on state, where the artificial intelligence assistant module is configured to monitor voice information input by the user, and the voice wake-up module is configured to recognize whether the voice information satisfies the voice wake-up condition.

According to one or more embodiments of the present disclosure, the method further includes:

in response to receiving second control information sent by the target application based on a terminal device, turning off the voice wake-up module of the voice input device, where the second control information is triggered by the target application when the voice wake-up switch is turned off; and detecting a switch state of the button wake-up switch, and if the button wake-up switch is in an off state, switching the working state of the artificial intelligence assistant module to an off state, and if the button wake-up switch is in an on state, keeping the working state of the artificial intelligence assistant module in an on state.

According to one or more embodiments of the present disclosure, controlling the button wake-up module of the voice input device based on the button wake-up switch of the target application includes:

in response to receiving third control information sent by the target application based on a target device, turning on the button wake-up module of the voice input device, where the third control information is triggered by the target application when the button wake-up switch is turned on, and the target device is a terminal device that is connected to the voice input device through Bluetooth; turning on the intercom module of the voice input device, and acquiring the working state of the artificial intelligence assistant module of the voice input device, and if the working state of the artificial intelligence assistant module is an off state, switching the working state of the artificial intelligence assistant module to an on state, where the intercom module is configured to receive, through the artificial intelligence assistant module after the artificial intelligence assistant of the target application is woken up, voice information input by the user.

According to one or more embodiments of the present disclosure, the method further includes:

in response to receiving fourth control information sent by the target application based on a terminal device, turning off the button wake-up module of the voice input device, where the fourth control information is triggered by the target application when the button wake-up switch is turned off; turning off the intercom module of the voice input device, and detecting a switch state of the voice wake-up switch, and if the voice wake-up switch is in an off state, switching the working state of the artificial intelligence assistant module to an off state, and if the voice wake-up switch is in an on state, keeping the working state of the artificial intelligence assistant module in an on state.

According to one or more embodiments of the present disclosure, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset; the method further includes:

if the third control information is triggered by the target application when the left button wake-up switch is turned on, turning on the button wake-up module of the left headset, turning on the intercom module of the left headset, and acquiring the working state of the artificial intelligence assistant module of the left headset, and if the working state of the artificial intelligence assistant module is an off state, switching the working state of the artificial intelligence assistant module to an on state; and if the third control information is triggered by the target application when the right button wake-up switch is turned on, turning on the button wake-up module of the right headset, turning on the intercom module of the right headset, and acquiring the working state of the artificial intelligence assistant module of the left headset, and if the working state of the artificial intelligence assistant module is an off state, switching the working state of the artificial intelligence assistant module to an on state, where the left headset is a main headset, and the right headset is a slave headset.

According to one or more embodiments of the present disclosure, the method further includes:

if the fourth control information is triggered by the target application when the left button wake-up switch is turned on, turning off the intercom module of the left headset, and detecting the switch state of the voice wake-up switch and a switch state of the right button wake-up switch, and if the voice wake-up switch and the right button wake-up switch are both in the off state, switching the working state of the artificial intelligence assistant module of the left headset to an off state, and if the voice wake-up switch is in the on state and/or the right button wake-up switch is in the on state, keeping the working state of the artificial intelligence assistant module of the left headset in an on state; and

if the fourth control information is triggered by the target application when the right button wake-up switch is turned on, turning off the intercom module of the right headset, and detecting the switch state of the voice wake-up switch and a switch state of the left button wake-up switch, and if the voice wake-up switch and the left button wake-up switch are both in the off state, switching the working state of the artificial intelligence assistant module of the left headset to an off state, and if the voice wake-up switch is in the on state and/or the left button wake-up switch is in the on state, keeping the working state of the artificial intelligence assistant module of the left headset in an on state.

According to one or more embodiments of the present disclosure, the method further includes: in response to a device state of the left headset being in a first device state, turning off the voice wake-up module, the button wake-up module, the artificial intelligence assistant module and the intercom module of the left headset; and in response to a device state of the right headset being in the first device state, turning off the button wake-up module and the intercom module of the right headset, where the first device state includes a call state, a charging state or a power-off state.

According to one or more embodiments of the present disclosure, the left headset is a main headset, and the right headset is a slave headset, and the method further includes: in response to the left headset being switched from the main headset to the slave headset, turning off the voice wake-up module and the artificial intelligence assistant module of the left headset, and detecting a switch state of the button wake-up switch of the left headset, and if the button wake-up switch of the left headset is in an on state, keeping the button wake-up module and the intercom module of the left headset in an on state, and if the button wake-up switch of the left headset is in an off state, turning off the button wake-up module and the intercom module of the left headset.

According to one or more embodiments of the present disclosure, the method further includes: in response to a binding operation between the target application and the voice input device, turning on the voice wake-up module, the button wake-up module, the artificial intelligence assistant module and the intercom module of the voice input device; and in response to an unbinding operation between the target application and the voice input device, turning off the voice wake-up module, the button wake-up module, the artificial intelligence assistant module and the intercom module of the voice input device.

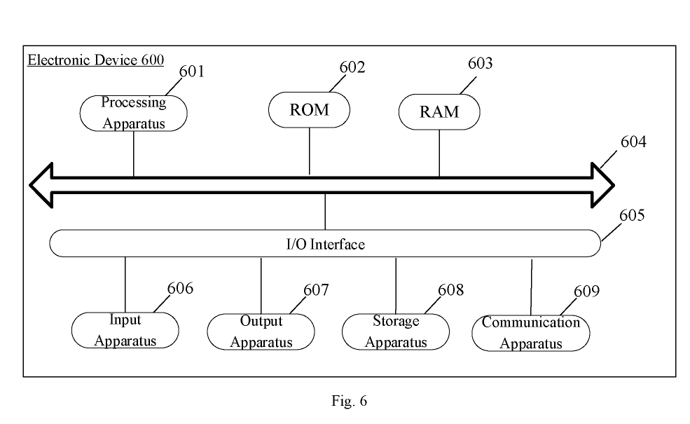

Referring to FIG. 6, it shows a schematic structural diagram of an electronic device 600 suitable for implementing embodiments of the present disclosure, and the electronic device 600 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and a stationary terminal such as a digital TV, a desktop computer, etc. The electronic device shown in FIG. 6 is only an example, which should not impose any limitation on the function and scope of use of the embodiments of the present disclosure.

As shown in FIG. 6, the electronic device 600 may include a processing apparatus (such as a central processing unit, a graphics processor, etc.) 601, which may perform various appropriate actions and processes according to a program stored in a read-only memory (abbreviated as ROM) 602 or a program loaded into a random-access memory (abbreviated as RAM) 603 from a storage apparatus 608. In the RAM 603, various programs and data required for the operation of the electronic device 600 are also stored. The processing apparatus 601, the ROM 602 and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (abbreviated as LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. While FIG. 6 shows an electronic device 600 with various apparatuses, it should be understood that not all of the illustrated apparatuses are required to be implemented or provided. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a computer-readable medium, where the computer program contains program codes for executing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiments of the present disclosure are executed.

It should be noted that the above-mentioned computer-readable medium in the present disclosure may be a computer-readable signal medium, a computer-readable storage medium, or any combination of the above two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program codes are carried in the data signal. The data signal propagated in this way may adopt multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program codes contained on the computer-readable medium may be transmitted by any suitable medium, including but not limited to: a wire, an optical cable, an RF (radio frequency), etc., or any suitable combination of the above.

The above-mentioned computer-readable medium may be included in the above-mentioned electronic device, or it may exist alone without being assembled into the electronic device.

The above-mentioned computer-readable medium carries one or more programs, and when the one or more programs are executed by the electronic device, the electronic device is caused to execute the method shown in the above-mentioned embodiments.

The computer program codes used to perform the operations of the present disclosure may be written in one or more programming languages or a combination thereof. The above-mentioned programming languages include object-oriented programming languages such as Java, Smalltalk, C++, and conventional procedural programming languages such as "C" language or similar programming languages. The program codes may be executed entirely on a user computer, partly on the user computer, as a stand-alone software package, partly on the user computer and partly on a remote computer, or entirely on the remote computer or server. In the case of involving a remote computer, the remote computer may be connected to the user computer through any kind of network, including a local area network (abbreviated as LAN) or a wide area network (abbreviated as WAN), or it may be connected to an external computer (for example, connected through the Internet using an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or flowchart, and the combination of blocks in the block diagram and/or flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of a unit does not constitute a limitation on the unit itself under certain circumstances.

The functions described above may be performed at least partially by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In a first aspect, a wake-up method for artificial intelligence assistant is provided, which is applied to a voice input device of a target application, where the target application is an application with an artificial intelligence assistant, and the method includes:

in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition;

in response to a button wake-up module of the voice input device being in an on state, and a button operation of the user being detected, recognizing whether the button operation satisfies a button wake-up condition, and waking up the artificial intelligence assistant of the target application in response to the button operation satisfying the button wake-up condition;

where the voice wake-up module and the button wake-up module of the voice input device are controlled based on a voice wake-up switch and a button wake-up switch of the target application, respectively.

According to one or more embodiments of the present disclosure, the voice input device includes a Bluetooth headset, and the Bluetooth headset includes a left headset and a right headset; the button wake-up switch of the target application includes a left button wake-up switch and a right button wake-up switch, where the left button wake-up switch is configured to control a button wake-up module of the left headset, and the right button wake-up switch is configured to control a button wake-up module of the right headset.

According to one or more embodiments of the present disclosure, controlling the voice wake-up module of the voice input device based on the voice wake-up switch of the target application includes: in response to receiving first control information sent by the target application based on a target device, turning on the voice wake-up module of the voice input device, where the first control information is triggered by the target application when the voice wake-up switch is turned on, and the target device is a terminal device that is connected to the voice input device through Bluetooth; acquiring a working state of the artificial intelligence assistant module of the voice input device; and in response to the working state of the artificial intelligence assistant module being an off state, switching the working state of the artificial intelligence assistant module to an on state, where the artificial intelligence assistant module is configured to monitor voice information input by the user, and the voice wake-up module is configured to recognize whether the voice information satisfies the voice wake-up condition.

According to one or more embodiments of the present disclosure, the method further includes:

in response to receiving second control information sent by the target application based on a terminal device, turning off the voice wake-up module of the voice input device, where the second control information is triggered by the target application when the voice wake-up switch is turned off; detecting a switch state of the button wake-up switch; in response to the button wake-up switch being in an off state, switching the working state of the artificial intelligence assistant module to an off state; and in response to the button wake-up switch being in an on state, keeping the working state of the artificial intelligence assistant module in an on state.

According to one or more embodiments of the present disclosure, controlling the button wake-up module of the voice input device based on the button wake-up switch of the target application includes:

in response to receiving third control information sent by the target application based on a target device, turning on the button wake-up module of the voice input device, where the third control information is triggered by the target application when the button wake-up switch is turned on, and the target device is a terminal device that is connected to the voice input device through Bluetooth; turning on the intercom module of the voice input device; acquiring the working state of the artificial intelligence assistant module of the voice input device; and in response to the working state of the artificial intelligence assistant module being an off state, switching the working state of the artificial intelligence assistant module to an on state, where the intercom module is configured to receive, through the artificial intelligence assistant module after the artificial intelligence assistant of the target application is woken up, voice information input by the user.

According to one or more embodiments of the present disclosure, the method further includes:

in response to receiving fourth control information sent by the target application based on a terminal device, turning off the button wake-up module of the voice input device, where the fourth control information is triggered by the target application when the button wake-up switch is turned off; turning off the intercom module of the voice input device; detecting a switch state of the voice wake-up switch; in response to the voice wake-up switch being in an off state, switching the working state of the artificial intelligence assistant module to an off state; and in response to the voice wake-up switch being in an on state, keeping the working state of the artificial intelligence assistant module in an on state.

According to one or more embodiments of the present disclosure, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset; the method further includes:

in response to the third control information being triggered by the target application when the left button wake-up switch is turned on, turning on the button wake-up module of the left headset, and turning on the intercom module of the left headset; acquiring the working state of the artificial intelligence assistant module of the left headset; and switching the working state of the artificial intelligence assistant module to an on state in response to the working state of the artificial intelligence assistant module being an off state; and

in response to the third control information being triggered by the target application when the right button wake-up switch is turned on, turning on the button wake-up module of the right headset, and turning on the intercom module of the right headset; acquiring the working state of the artificial intelligence assistant module of the left headset; and switching the working state of the artificial intelligence assistant module to an on state in response to the working state of the artificial intelligence assistant module being an off state, where the left headset is a main headset, and the right headset is a slave headset.

According to one or more embodiments of the present disclosure, the method further includes:

in response to the fourth control information being triggered by the target application when the left button wake-up switch is turned on, turning off the intercom module of the left headset; detecting the switch state of the voice wake-up switch and a switch state of the right button wake-up switch; in response to the voice wake-up switch and the right button wake-up switch being both in the off state, switching the working state of the artificial intelligence assistant module of the left headset to an off state; and in response to the voice wake-up switch being in the on state and/or the right button wake-up switch being in the on state, keeping the working state of the artificial intelligence assistant module of the left headset in an on state; and

in response to the fourth control information being triggered by the target application when the right button wake-up switch is turned on, turning off the intercom module of the right headset; detecting the switch state of the voice wake-up switch and a switch state of the left button wake-up switch; in response to the voice wake-up switch and the left button wake-up switch being both in the off state, switching the working state of the artificial intelligence assistant module of the left headset to an off state; and in response to the voice wake-up switch being in the on state and/or the left button wake-up switch being in the on state, keeping the working state of the artificial intelligence assistant module of the left headset in an on state.

According to one or more embodiments of the present disclosure, the method further includes: in response to a device state of the left headset being in a first device state, turning off the voice wake-up module, the button wake-up module, the artificial intelligence assistant module and the intercom module of the left headset; and in response to a device state of the right headset being in the first device state, turning off the button wake-up module and the intercom module of the right headset, where the first device state includes a call state, a charging state or a power-off state.

According to one or more embodiments of the present disclosure, the left headset is a main headset, and the right headset is a slave headset, and the method further includes: in response to the left headset being switched from the main headset to the slave headset, turning off the voice wake-up module and the artificial intelligence assistant module of the left headset; detecting a switch state of the button wake-up switch of the left headset; in response to the button wake-up switch of the left headset being in an on state, keeping the button wake-up module and the intercom module of the left headset in an on state; and in response to the button wake-up switch of the left headset being in an off state, turning off the button wake-up module and the intercom module of the left headset.

According to one or more embodiments of the present disclosure, the method further includes: in response to a binding operation between the target application and the voice input device, turning on the voice wake-up module, the button wake-up module, the artificial intelligence assistant module and the intercom module of the voice input device; and in response to an unbinding operation between the target application and the voice input device, turning off the voice wake-up module, the button wake-up module, the artificial intelligence assistant module and the intercom module of the voice input device.

In a second aspect, a wake-up apparatus for artificial intelligence assistant is provided, which is applied to a voice input device of a target application, where the target application is an application with an artificial intelligence assistant, and the apparatus includes:

a first wake-up module, configured to: in response to a voice wake-up module of the voice input device being in an on state, and voice information that is input by a user being detected, recognize whether the voice information satisfies a voice wake-up condition, and wake up the artificial intelligence assistant of the target application in response to the voice information satisfying the voice wake-up condition;

a second wake-up module, configured to: in response to a button wake-up module of the voice input device being in an on state, and a button operation of the user being detected, recognize whether the button operation satisfies a button wake-up condition, and wake up the artificial intelligence assistant of the target application in response to the button operation satisfying the button wake-up condition;

where the voice wake-up module and the button wake-up module of the voice input device are controlled based on a voice wake-up switch and a button wake-up switch of the target application, respectively.

According to one or more embodiments of the present disclosure, the voice input device includes a Bluetooth headset, and the Bluetooth headset includes a left headset and a right headset; the button wake-up switch of the target application includes a left button wake-up switch and a right button wake-up switch, where the left button wake-up switch is configured to control a button wake-up module of the left headset, and the right button wake-up switch is configured to control a button wake-up module of the right headset.

According to one or more embodiments of the present disclosure, controlling the voice wake-up module of the voice input device based on the voice wake-up switch of the target application includes: in response to receiving first control information sent by the target application based on a target device, turning on the voice wake-up module of the voice input device, where the first control information is triggered by the target application when the voice wake-up switch is turned on, and the target device is a terminal device that is connected to the voice input device through Bluetooth; acquiring a working state of the artificial intelligence assistant module of the voice input device; and switching the working state of the artificial intelligence assistant module to an on state in response to the working state of the artificial intelligence assistant module being an off state, where the artificial intelligence assistant module is configured to monitor voice information input by the user, and the voice wake-up module is configured to recognize whether the voice information satisfies the voice wake-up condition.

According to one or more embodiments of the present disclosure, the method further includes:

in response to receiving second control information sent by the target application based on a terminal device, turning off the voice wake-up module of the voice input device, where the second control information is triggered by the target application when the voice wake-up switch is turned off; detecting a switch state of the button wake-up switch; in response to the button wake-up switch being in an off state, switching the working state of the artificial intelligence assistant module to an off state; and in response to the button wake-up switch being in an on state, keeping the working state of the artificial intelligence assistant module in an on state.

According to one or more embodiments of the present disclosure, controlling the button wake-up module of the voice input device based on the button wake-up switch of the target application includes:

in response to receiving third control information sent by the target application based on a target device, turning on the button wake-up module of the voice input device, where the third control information is triggered by the target application when the button wake-up switch is turned on, and the target device is a terminal device that is connected to the voice input device through Bluetooth; turning on the intercom module of the voice input device; acquiring the working state of the artificial intelligence assistant module of the voice input device; and in response to the working state of the artificial intelligence assistant module being an off state, switching the working state of the artificial intelligence assistant module to an on state, where the intercom module is configured to receive, through the artificial intelligence assistant module after the artificial intelligence assistant of the target application is woken up, voice information input by the user.

According to one or more embodiments of the present disclosure, the method further includes:

in response to receiving fourth control information sent by the target application based on a terminal device, turning off the button wake-up module of the voice input device, where the fourth control information is triggered by the target application when the button wake-up switch is turned off; turning off the intercom module of the voice input device; detecting a switch state of the voice wake-up switch; in response to the voice wake-up switch being in an off state, switching the working state of the artificial intelligence assistant module to an off state; and in response to the voice wake-up switch being in an on state, keeping the working state of the artificial intelligence assistant module in an on state.

According to one or more embodiments of the present disclosure, the voice input device includes a Bluetooth headset, and the Bluetooth headset includes a left headset and a right headset; the button wake-up switch includes a left button wake-up switch and a right button wake-up switch, where the left button wake-up switch is configured to control a button wake-up module of the left headset, and the right button wake-up switch is configured to control a button wake-up module of the right headset; the method further includes:

in response to the third control information being triggered by the target application when the left button wake-up switch is turned on, turning on the button wake-up module of the left headset, turning on the intercom module of the left headset; acquiring the working state of the artificial intelligence assistant module of the left headset; and in response to the working state of the artificial intelligence assistant module being an off state, switching the working state of the artificial intelligence assistant module to an on state; and

in response to the third control information being triggered by the target application when the right button wake-up switch is turned on, turning on the button wake-up module of the right headset, and turning on the intercom module of the right headset; acquiring the working state of the artificial intelligence assistant module of the left headset; and in response to the working state of the artificial intelligence assistant module being an off state, switching the working state of the artificial intelligence assistant module to an on state, where the left headset is a main headset, and the right headset is a slave headset.

According to one or more embodiments of the present disclosure, the method further includes:

in response to the fourth control information being triggered by the target application when the left button wake-up switch is turned on, turning off the intercom module of the left headset; detecting the switch state of the voice wake-up switch and a switch state of the right button wake-up switch; in response to the voice wake-up switch and the right button wake-up switch being both in the off state, switching the working state of the artificial intelligence assistant module of the left headset to an off state; and in response to the voice wake-up switch being in the on state and/or the right button wake-up switch being in the on state, keeping the working state of the artificial intelligence assistant module of the left headset in an on state; and

in response to the fourth control information being triggered by the target application when the right button wake-up switch is turned on, turning off the intercom module of the right headset; detecting the switch state of the voice wake-up switch and a switch state of the left button wake-up switch; in response to the voice wake-up switch and the left button wake-up switch being both in the off state, switching the working state of the artificial intelligence assistant module of the left headset to an off state; and in response to the voice wake-up switch being in the on state and/or the left button wake-up switch being in the on state, keeping the working state of the artificial intelligence assistant module of the left headset in an on state.

According to one or more embodiments of the present disclosure, the method further includes: in response to a device state of the left headset being in a first device state, turning off the voice wake-up module, the button wake-up module, the artificial intelligence assistant module and the intercom module of the left headset; and in response to a device state of the right headset being in the first device state, turning off the voice wake-up module, the button wake-up module, the artificial intelligence assistant module and the intercom module of the right headset, where the first device state includes a call state, a charging state or a power-off state.

According to one or more embodiments of the present disclosure, the left headset is a main headset, and the right headset is a slave headset, and the method further includes: in response to the left headset being switched from the main headset to the slave headset, turning off the voice wake-up module and the artificial intelligence assistant module of the left headset; detecting a switch state of the button wake-up switch of the left headset; in response to the button wake-up switch of the left headset being in an on state, keeping the button wake-up module and the intercom module of the left headset in an on state; and in response to the button wake-up switch of the left headset being in an off state, turning off the button wake-up module and the intercom module of the left headset.

According to one or more embodiments of the present disclosure, the method further includes: in response to a binding operation between the target application and the voice input device, turning on the voice wake-up module, the button wake-up module, the artificial intelligence assistant module and the intercom module of the voice input device; and in response to an unbinding operation between the target application and the voice input device, turning off the voice wake-up module, the button wake-up module, the artificial intelligence assistant module and the intercom module of the voice input device.

In a third aspect, according to one or more embodiments of the present disclosure, an electronic device is provided, including: at least one processor and a memory, where

the memory stores computer-executable instructions; and

the computer-executable instructions stored in the memory, when executed by the at least one processor, cause the at least one processor to execute the wake-up method for artificial intelligence assistant according to the above first aspect and various possible designs of the first aspect.

In a fourth aspect, according to one or more embodiments of the present disclosure, a non-transient computer-readable storage medium is provided, where computer-executable instructions are stored in the computer-readable storage medium, and when the computer-executable instructions are executed by at least one processor, the wake-up method for artificial intelligence assistant according to the above first aspect and various possible designs of the first aspect is implemented.

In a fifth aspect, according to one or more embodiments of the present disclosure, a computer program product is provided, including a computer program, and when the computer program is executed by at least one processor, the wake-up method for artificial intelligence assistant according to the above first aspect and various possible designs of the first aspect is implemented.

The above description is only preferred embodiments of the present disclosure and an explanation of the applied technical principles. Those skilled in the art should understand that the disclosed scope involved in the present disclosure is not limited to the technical solution formed by the specific combination of the above technical features, but also covers other technical solutions formed by any combination of the above technical features or their equivalent features without departing from the above disclosed concept. For example, technical solutions may be formed by the above features and (but not limited to) technical features with similar functions disclosed in the present disclosure which are replaced with each other.

In addition, although the operations are depicted in a specific order, this should not be understood as requiring the operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are only exemplary forms for implementing the claims.

1. A wake-up method for artificial intelligence assistant, applied to a voice input device of a target application, wherein the target application is an application with an artificial intelligence assistant, and the method comprises:
in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition; and
in response to a button wake-up module of the voice input device being in an on state, and a button operation of the user being detected, recognizing whether the button operation satisfies a button wake-up condition, and waking up the artificial intelligence assistant of the target application in response to the button operation satisfying the button wake-up condition;
wherein the voice wake-up module and the button wake-up module of the voice input device are controlled based on a voice wake-up switch and a button wake-up switch of the target application, respectively.

2. The method of claim 1, wherein the voice input device comprises a Bluetooth headset, the Bluetooth headset comprises a left headset and a right headset, the left headset is a main headset, and the right headset is a slave headset;
the button wake-up switch of the target application comprises a left button wake-up switch and a right button wake-up switch, wherein the left button wake-up switch is configured to control the button wake-up module of the left headset, the right button wake-up switch is configured to control the button wake-up module of the right headset, and the voice wake-up switch is configured to control the voice wake-up module of the left headset.

3. The method of claim 1, wherein controlling the voice wake-up module of the voice input device based on the voice wake-up switch of the target application comprises:
in response to receiving first control information sent by the target application based on a target device, turning on the voice wake-up module of the voice input device, wherein the first control information is triggered by the target application turning on the voice wake-up switch, and the target device is a terminal device that is connected to the voice input device through Bluetooth;
acquiring a working state of an artificial intelligence assistant module of the voice input device, and
in response to the working state of the artificial intelligence assistant module being an off state, switching the working state of the artificial intelligence assistant module to an on state;
wherein the artificial intelligence assistant module is configured to monitor the voice information input by the user, and the voice wake-up module is configured to recognize whether the voice information satisfies the voice wake-up condition.

4. The method of claim 3, further comprising:
in response to receiving second control information sent by the target application based on a terminal device, turning off the voice wake-up module of the voice input device, wherein the second control information is triggered by the target application turning off the voice wake-up switch;
detecting a switch state of the button wake-up switch;
in response to the button wake-up switch being in an off state, switching the working state of the artificial intelligence assistant module to an off state, and
in response to the button wake-up switch being in an on state, keeping the working state of the artificial intelligence assistant module in an on state.

5. The method of claim 1, wherein controlling the button wake-up module of the voice input device based on the button wake-up switch of the target application comprises:
in response to receiving third control information sent by the target application based on a target device, turning on the button wake-up module of the voice input device, wherein the third control information is triggered by the target application turning on the button wake-up switch, and the target device is a terminal device that is connected to the voice input device through Bluetooth;
turning on an intercom module of the voice input device;
acquiring a working state of an artificial intelligence assistant module of the voice input device, and
in response to the working state of the artificial intelligence assistant module being an off state, switching the working state of the artificial intelligence assistant module to an on state;
wherein the intercom module is configured to receive, through the artificial intelligence assistant module after the artificial intelligence assistant of the target application is woken up, voice information input by the user.

6. The method of claim 5, further comprising:
in response to receiving fourth control information sent by the target application based on a terminal device, turning off the button wake-up module of the voice input device, wherein the fourth control information is triggered by the target application turning off the button wake-up switch;
turning off the intercom module of the voice input device;
detecting a switch state of the voice wake-up switch;
in response to the voice wake-up switch being in an off state, switching the working state of the artificial intelligence assistant module to an off state; and
in response to the voice wake-up switch being in an on state, keeping the working state of the artificial intelligence assistant module in an on state.

7. The method of claim 6, wherein the voice input device comprises a Bluetooth headset, and the Bluetooth headset comprises a left headset and a right headset; the button wake-up switch comprises a left button wake-up switch and a right button wake-up switch, wherein the left button wake-up switch is configured to control a button wake-up module of the left headset, and the right button wake-up switch is configured to control a button wake-up module of the right headset; the method further comprises:
in response to the third control information being triggered by the target application turning on the left button wake-up switch, turning on the button wake-up module of the left headset, and turning on an intercom module of the left headset; acquiring a working state of an artificial intelligence assistant module of the left headset; and in response to the working state of the artificial intelligence assistant module being an off state, switching the working state of the artificial intelligence assistant module to an on state; and
in response to the third control information being triggered by the target application turning on the right button wake-up switch, turning on the button wake-up module of the right headset, and turning on an intercom module of the right headset; acquiring the working state of the artificial intelligence assistant module of the left headset; and in response to the working state of the artificial intelligence assistant module being an off state, switching the working state of the artificial intelligence assistant module to an on state;
wherein the left headset is a main headset, and the right headset is a slave headset.

8. The method of claim 7, further comprising:
in response to the fourth control information being triggered by the target application turning on the left button wake-up switch, turning off the intercom module of the left headset; detecting the switch state of the voice wake-up switch and a switch state of the right button wake-up switch; in response to the voice wake-up switch and the right button wake-up switch being both in the off state, switching the working state of the artificial intelligence assistant module of the left headset to an off state; and in response to at least one of the voice wake-up switch and the right button wake-up switch being in the on state, keeping the working state of the artificial intelligence assistant module of the left headset in an on state; and
in response to the fourth control information being triggered by the target application turning on the right button wake-up switch, turning off the intercom module of the right headset; detecting the switch state of the voice wake-up switch and a switch state of the left button wake-up switch; in response to the voice wake-up switch and the left button wake-up switch being both in the off state, switching the working state of the artificial intelligence assistant module of the left headset to an off state; and in response to at least one of the voice wake-up switch and the left button wake-up switch being in the on state, keeping the working state of the artificial intelligence assistant module of the left headset in an on state.

9. The method of claim 2, further comprising:
in response to a device state of the left headset being in a first device state, turning off the voice wake-up module, the button wake-up module, the artificial intelligence assistant module and an intercom module of the left headset; and
in response to a device state of the right headset being in the first device state, turning off the button wake-up module and an intercom module of the right headset;
wherein the first device state comprises a call state, a charging state or a power-off state.

10. The method of claim 2, further comprising:
in response to the left headset being switched from the main headset to the slave headset, turning off the voice wake-up module and the artificial intelligence assistant module of the left headset;
detecting a switch state of the button wake-up switch of the left headset;
in response to the button wake-up switch of the left headset being in an on state, keeping the button wake-up module and an intercom module of the left headset in an on state; and
in response to the button wake-up switch of the left headset being in an off state, turning off the button wake-up module and the intercom module of the left headset.

11. The method of claim 1, further comprising:
in response to a binding operation between the target application and the voice input device, turning on the voice wake-up module, the button wake-up module, the artificial intelligence assistant module and an intercom module of the voice input device; and
in response to an unbinding operation between the target application and the voice input device, turning off the voice wake-up module, the button wake-up module, the artificial intelligence assistant module and the intercom module of the voice input device.

12. An electronic device, comprising: at least one processor and a memory, wherein
the memory stores computer-executable instructions; and
the computer-executable instructions stored in the memory, when executed by the at least one processor, cause the at least one processor to perform a wake-up method for artificial intelligence assistant,
wherein the wake-up method is applied to a voice input device of a target application, the target application is an application with an artificial intelligence assistant, and the wake-up method comprises:
in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition; and
in response to a button wake-up module of the voice input device being in an on state, and a button operation of the user being detected, recognizing whether the button operation satisfies a button wake-up condition, and waking up the artificial intelligence assistant of the target application in response to the button operation satisfying the button wake-up condition;
wherein the voice wake-up module and the button wake-up module of the voice input device are controlled based on a voice wake-up switch and a button wake-up switch of the target application, respectively.

13. The electronic device of claim 12, wherein the voice input device comprises a Bluetooth headset, the Bluetooth headset comprises a left headset and a right headset, the left headset is a main headset, and the right headset is a slave headset;
the button wake-up switch of the target application comprises a left button wake-up switch and a right button wake-up switch, wherein the left button wake-up switch is configured to control the button wake-up module of the left headset, the right button wake-up switch is configured to control the button wake-up module of the right headset, and the voice wake-up switch is configured to control the voice wake-up module of the left headset.

14. The electronic device of claim 12, wherein controlling the voice wake-up module of the voice input device based on the voice wake-up switch of the target application comprises:
in response to receiving first control information sent by the target application based on a target device, turning on the voice wake-up module of the voice input device, wherein the first control information is triggered by the target application turning on the voice wake-up switch, and the target device is a terminal device that is connected to the voice input device through Bluetooth;
acquiring a working state of an artificial intelligence assistant module of the voice input device, and
in response to the working state of the artificial intelligence assistant module being an off state, switching the working state of the artificial intelligence assistant module to an on state;
wherein the artificial intelligence assistant module is configured to monitor the voice information input by the user, and the voice wake-up module is configured to recognize whether the voice information satisfies the voice wake-up condition.

15. The electronic device of claim 14, wherein the wake-up method further comprises:
in response to receiving second control information sent by the target application based on a terminal device, turning off the voice wake-up module of the voice input device, wherein the second control information is triggered by the target application turning off the voice wake-up switch;
detecting a switch state of the button wake-up switch;
in response to the button wake-up switch being in an off state, switching the working state of the artificial intelligence assistant module to an off state, and
in response to the button wake-up switch being in an on state, keeping the working state of the artificial intelligence assistant module in an on state.

16. The electronic device of claim 12, wherein controlling the button wake-up module of the voice input device based on the button wake-up switch of the target application comprises:
in response to receiving third control information sent by the target application based on a target device, turning on the button wake-up module of the voice input device, wherein the third control information is triggered by the target application turning on the button wake-up switch, and the target device is a terminal device that is connected to the voice input device through Bluetooth;
turning on an intercom module of the voice input device;
acquiring a working state of an artificial intelligence assistant module of the voice input device, and
in response to the working state of the artificial intelligence assistant module being an off state, switching the working state of the artificial intelligence assistant module to an on state;
wherein the intercom module is configured to receive, through the artificial intelligence assistant module after the artificial intelligence assistant of the target application is woken up, voice information input by the user.

17. The electronic device of claim 16, wherein the wake-up method further comprises:
in response to receiving fourth control information sent by the target application based on a terminal device, turning off the button wake-up module of the voice input device, wherein the fourth control information is triggered by the target application turning off the button wake-up switch;
turning off the intercom module of the voice input device;
detecting a switch state of the voice wake-up switch;
in response to the voice wake-up switch being in an off state, switching the working state of the artificial intelligence assistant module to an off state; and
in response to the voice wake-up switch being in an on state, keeping the working state of the artificial intelligence assistant module in an on state.

18. The electronic device of claim 17, wherein the voice input device comprises a Bluetooth headset, and the Bluetooth headset comprises a left headset and a right headset; the button wake-up switch comprises a left button wake-up switch and a right button wake-up switch, wherein the left button wake-up switch is configured to control a button wake-up module of the left headset, and the right button wake-up switch is configured to control a button wake-up module of the right headset; the method further comprises:
in response to the third control information being triggered by the target application turning on the left button wake-up switch, turning on the button wake-up module of the left headset, and turning on an intercom module of the left headset; acquiring a working state of an artificial intelligence assistant module of the left headset; and in response to the working state of the artificial intelligence assistant module being an off state, switching the working state of the artificial intelligence assistant module to an on state; and
in response to the third control information being triggered by the target application turning on the right button wake-up switch, turning on the button wake-up module of the right headset, and turning on an intercom module of the right headset; acquiring the working state of the artificial intelligence assistant module of the left headset; and in response to the working state of the artificial intelligence assistant module being an off state, switching the working state of the artificial intelligence assistant module to an on state;
wherein the left headset is a main headset, and the right headset is a slave headset.

19. The electronic device of claim 18, wherein the wake-up method further comprises:
in response to the fourth control information being triggered by the target application turning on the left button wake-up switch, turning off the intercom module of the left headset; detecting the switch state of the voice wake-up switch and a switch state of the right button wake-up switch; in response to the voice wake-up switch and the right button wake-up switch being both in the off state, switching the working state of the artificial intelligence assistant module of the left headset to an off state; and in response to at least one of the voice wake-up switch and the right button wake-up switch being in the on state, keeping the working state of the artificial intelligence assistant module of the left headset in an on state; and
in response to the fourth control information being triggered by the target application turning on the right button wake-up switch, turning off the intercom module of the right headset; detecting the switch state of the voice wake-up switch and a switch state of the left button wake-up switch; in response to the voice wake-up switch and the left button wake-up switch being both in the off state, switching the working state of the artificial intelligence assistant module of the left headset to an off state; and in response to at least one of the voice wake-up switch and the left button wake-up switch being in the on state, keeping the working state of the artificial intelligence assistant module of the left headset in an on state.

20. A non-transient computer-readable storage medium comprising computer-executable instructions stored therein, wherein the computer-executable instructions, when executed by at least one processor, cause the at least one processor to perform a wake-up method for artificial intelligence assistant,
wherein the wake-up method is applied to a voice input device of a target application, the target application is an application with an artificial intelligence assistant, and the wake-up method comprises:
in response to a voice wake-up module of the voice input device being in an on state, and voice information that is input by a user being detected, recognizing whether the voice information satisfies a voice wake-up condition, and waking up the artificial intelligence assistant of the target application in response to the voice information satisfying the voice wake-up condition; and
in response to a button wake-up module of the voice input device being in an on state, and a button operation of the user being detected, recognizing whether the button operation satisfies a button wake-up condition, and waking up the artificial intelligence assistant of the target application in response to the button operation satisfying the button wake-up condition;
wherein the voice wake-up module and the button wake-up module of the voice input device are controlled based on a voice wake-up switch and a button wake-up switch of the target application, respectively.
